(19) United States
(12) Patent Application Publication
(10) Pub. No.: US 2025/0378809 A1
(43) Pub. Date: Dec. 11, 2025

(54) MULTIBAND AND BROADBAND SOUND ABSORBING METAMATERIALS FOR NOISE CANCELLATION

(71) Applicant: Dell Products L.P., Round Rock, TX (US)

(72) Inventors: Tejinder Singh, Manotick (CA); Kan Wang, Ottawa (CA); Navjot Kaur Khaira, Manotick (CA)

(21) Appl. No.: 18/734,408

(22) Filed: Jun. 5, 2024

(51) Int. Cl. G10K 11/16

(52) U.S. Cl. CPC G10K 11/16

(57) ABSTRACT

The technology described herein is directed towards a metasurface arranged with unit cells for broadband and/or multiband sound absorption, in which the unit cells are based on the principles of Helmholtz resonators. Deeply subwavelength sound absorbing unit cells are designed and constructed based on desired resonance frequencies. Each unit cell includes a neck portion and air chamber dimensioned to resonate at a desired resonance frequency and thereby inverse phase cancel corresponding frequencies of incoming sound waves. Differently designed and arranged subgroups of unit cells are part of the metasurface, which can be positioned proximate to a noise source. As practical examples, the metasurface or multiple metasurfaces can be placed near or wrapped around a computer server or rack of servers to absorb fan noise. The metasurface components (including the unit cells) can be printed by a 3D printer to result in a thin, light-weight, and cost effective noise absorbing metasurface.

### BACKGROUND

Acoustic absorbers are specialized materials or structures designed to mitigate the effects of sound reflections, echoes, and reverberations in various environments. These absorbers function by capturing sound waves and converting their energy into heat, effectively reducing the intensity of the sound waves and preventing them from bouncing off surfaces and causing unwanted sound reflections. They are typically engineered using porous materials with intricate structures that allow sound waves to penetrate deep into the material, where the acoustic energy is dissipated as thermal energy through friction and air resistance.

Existing acoustic absorbers come in various forms, including foam panels, fabric-wrapped panels, diffusers, bass traps, and more. One of the problems with existing acoustic absorbers is that they are not desirable in certain heat-sensitive environments. For example, servers generate a lot of heat and thus are designed with fans to cool dissipate the heat; however, fans can generate a lot of annoying noise. Using existing acoustic absorbers to absorb server noise reduces the noise but can significantly reduce dissipation of the heat generated by servers, which can result in high heat levels that can reduce server performance and possibly cause a server to shut down to avoid damage from overheating.

### BRIEF DESCRIPTION OF THE DRAWINGS

The technology described herein is illustrated by way of example and not limited in the accompanying figures in which like reference numerals indicate similar elements and in which:

FIG. 1 is a block diagram showing an example system for implementing a metasurface with resonating unit cells for noise cancellation by phase canceling two or more narrowband frequencies in acoustic waves, in accordance with various embodiments and implementations of the subject disclosure.

FIG. 2 is a representation of an example metasurface deployed for noise cancellation, in accordance with various embodiments and implementations of the subject disclosure.

FIG. 3 is a two-dimensional side view representation of example unit-cells including one enlarged representation of a unit cell showing various dimensions that determine the unit cell's resonance frequency, and three unit cells forming different Helmholtz resonators for absorbing three different acoustic frequencies, in accordance with various embodiments and implementations of the subject disclosure.

FIG. 4 is a graphical representation of resulting absorption coefficient values of the three unit-cell of FIG. 3, indicating three very high reflection coefficient values for three different frequencies resulting in multiband frequency absorption, in accordance with various embodiments and implementations of the subject disclosure.

FIG. 5 is a graphical representation of resulting absorption coefficient values of three other unit-cells (relative to FIG. 4), showing three very high reflection coefficient values for three different frequencies, resulting in broadband frequency absorption, in accordance with various embodiments and implementations of the subject disclosure.

FIG. 6 is a representation of an example portion of a sound absorbing metasurface showing an enlarged view of three of a metasurface's adjacent unit cells positioned to phase cancel different frequencies within incoming acoustic waves from a server, in accordance with various embodiments and implementations of the subject disclosure.

FIG. 7 is a representation of an example portion of a sound absorbing metasurface showing an enlarged view of a metasurface's adjacent unit cells positioned to phase cancel multiple frequencies within incoming acoustic waves from a rack of servers, in accordance with various embodiments and implementations of the subject disclosure.

FIG. 8 is a three-dimensional, perspective representation of example sound absorbing metasurfaces composed of unit cells for wrapping around a rack of servers to reduce multiple frequency noise emanating from the servers, in accordance with various embodiments and implementations of the subject disclosure.

FIG. 9. is a representation of an example experimental setup and graphical representations of an example measurement result of a sound spectrum emanating from a server measured outside of and inside the same room as the server, in accordance with various embodiments and implementations of the subject disclosure.

FIGS. 10A and 10B are graphical representations of an example measurement result of a sound spectrum emanating from a server measured from of and inside a server's room, respectively, in accordance with various embodiments and implementations of the subject disclosure.

FIGS. 11 and 12 comprise a flow diagram showing example operations related to controlling a device to construct a first unit cell, second unit cell and third unit cell, corresponding to first, second and third frequencies to phase cancel, respectively, in accordance with various embodiments and implementations of the subject disclosure.

### DETAILED DESCRIPTION

Various embodiments and implementations of the technology described herein are generally directed towards a multiband and/or broadband sound absorption device based on inverted phase cancellation, and more particularly towards an acoustic absorbing metasurface based on the principles of Helmholtz resonators. The technology described herein facilitates the design and implementation of unit cells into metasurfaces that can be configured and positioned to efficiently absorb and dissipate sound waves of two or more specific frequencies. Each of the specific frequencies can be of any frequency/narrowband frequency range over a broad range of audible frequencies, or even subsonic (below 20 Hz)/supersonic frequencies (up to about 20,000 Hz). Two or more of the specific frequencies can be relatively far apart, whereby multiband sound absorption is facilitated for such far apart frequencies. Two or more of the specific frequencies can be relatively close together, whereby broadband sound absorption is facilitated for such close together frequencies.

The sound absorption metasurfaces can be designed for absorbing the multifrequency acoustic waves (noise) emanating from one or more server fans. Significantly, the use of metasurfaces as described herein does not increase the heat levels of computing devices substantially, compared to existing technologies for sound absorption that do not facilitate ventilation/do not dissipate the heat very well.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

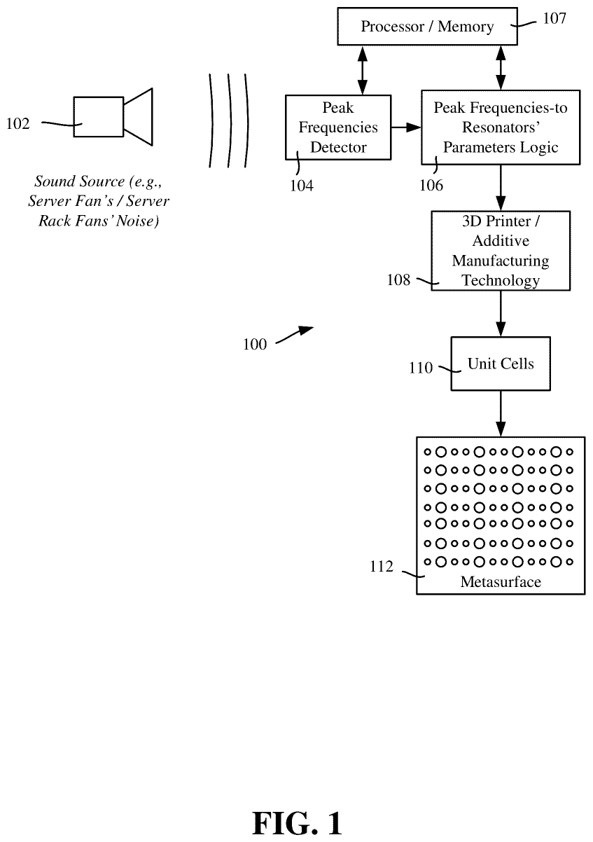

FIG. 1 shows a generalized block diagram of an example system 100 including a sound source 102 such as server fan/fans of a rack of servers that generate undesirable noise including at two or more frequencies that are to be absorbed based on the technology described herein. A frequency measurement tool can be used as a peak frequency detector 104 or the like to determine which frequencies to cancel as described herein. As will be seen, the frequencies are absorbed extremely efficiently by the technology described herein, including each of the frequencies within a narrow band of nearby frequencies that are also reduced to a lesser, but still desirable, extent.

In general, Helmholtz resonators operate as a compact, highly efficient sound absorption solution when compared to other alternatives; however, a limitation of a Helmholtz resonator is its narrow-band frequency response. To address this narrow-band constraint, described herein is designing and implementing a super-cell concept in the form of a metasurface for sound absorption. By utilizing a rectangular grid arrangement of super-cells, each housing sub-cells (subgroups of unit cells) with distinct resonating frequencies, multifrequency sound absorption and/or broadband sound absorption can be achieved.

Returning to FIG. 1, once the frequencies to cancel are determined, e.g., the peak frequencies, peak frequencies-to-resonators' parameter logic 106 (e.g., executing in a processor/memory 107) can be used to determine the parameters of unit cells that can inverse phase cancel each of those frequencies. In one or more example implementations, a 3D printer/additive manufacturing technology can be used to construct the unit cells 110 based on the parameters, e.g., forming a metasurface 112, such as by omitting printing where the chambers and neck ports of the unit cells are located.

The unit cells 110 can be based on the principles of Helmholtz resonators, which are acoustic cavities with a small neck port or opening that are highly effective at absorbing specific frequencies via resonance. For example, the resonant frequency (f₀) of a classical Helmholtz resonator is denoted by:

$${f}_{0} = \frac{c}{2 π} \sqrt{\frac{S}{{L}_{p} V}}$$

where, c is the speed of sound in the medium interested, S is the neck cross-sectional area, Lₚ=l_{neck}+1.7r_{neck} is the length of the neck assuming cylinder shape, (r_{neck} is the radius of the neck), and V is the volume of the cavity. Setting the resonance frequencies to the narrow-band noise frequencies, the parameters of the resonator can be computed using the above mentioned equation.

This resonance occurs because within the cavity, the sound waves bounce back and forth, with the neck acting as a spring, allowing air to flow in and out. When the frequency of the incoming sound matches the natural resonant frequency of the cavity, a substantial increase in energy absorption takes place. This energy absorption results in a significant reduction of sound at the resonant frequency.

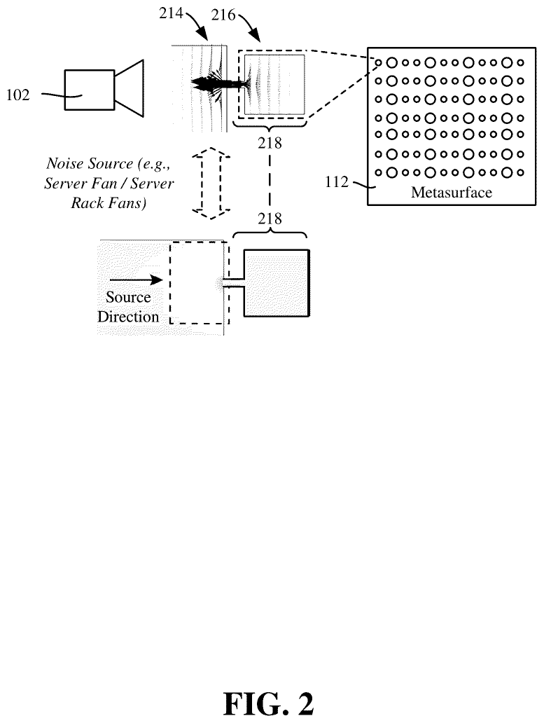

The unit cells 110, each represented as a small circle in FIGS. 1 and 2, are incorporated into the metasurface 112, which can then be positioned to cancel the noise source at the determined frequency. In one implementation, the metasurface 112 contains an array of the unit cell resonator units arranged in one two-dimensional pattern interleaved with the unit cells of one or more other two-dimensional patterns. For absorbing a server's fan noise, for example, the metasurface 112 can be positioned proximate to the server's location, or even wrapped around at least part of the server's housing. The same metasurface noise-cancellation concept can be extended to a rack of servers via appropriately-sized (e.g., larger) and/or more metasurfaces.

As generally represented in FIG. 2, when incident sound waves (block 214) interact with the metasurface 112, the Helmholtz resonators within the array selectively absorb the corresponding frequencies via inverse phase cancellation; absorption of one such frequency is represented by vectors in blocks 214 and 216). As sound waves enter the resonators (e.g., the resonator 218) through its neck port, the sound waves create pressure fluctuations within the cavities. By engineering the geometrical parameters of the cavity/air chamber, the resulting resonance frequency of the unit cell creates a π phase shift reflected wave with respect to the incident waves as shown in FIG. 2, where the two sets of waves with opposite phase cancel, effectively absorbing the frequency (of one of the multiple frequencies to be absorbed). This is highlighted via the air velocity vector plot showing the direction of the reflected wave with x phase shift in the upper portion of FIG. 2. In addition, these pressure fluctuations also cause the air inside the cavities to oscillate, effectively converting acoustic energy into kinetic energy. This kinetic energy is then dissipated as heat through viscous losses in the narrow neck of the resonators, however the heat dissipation is appreciably better relative to traditional sound absorbers and does not significantly affect thermal performance of a server.

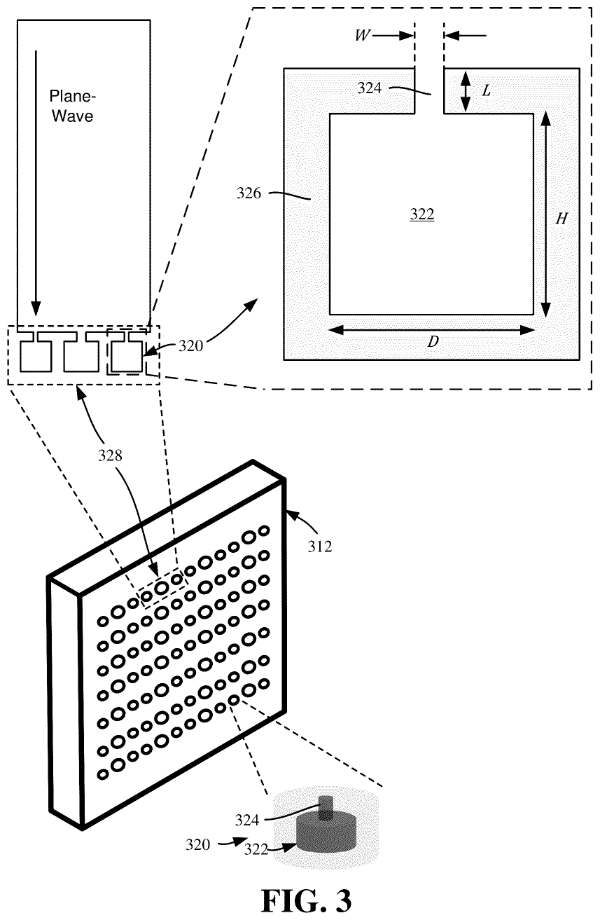

As generally represented in FIG. 3, each unit cell (e.g., 320) comprises a cavity, or air chamber 322, often with a neck port 324 that exposes the air chamber to the air/incoming sound waves, with dimensions engineered to target a particular frequency or a narrowband range of frequencies of interest. The dimensions of the air chamber 322 and neck port 324 are designed based on the desired acoustic frequencies, allowing the unit cells of the metasurface 312 to resonate when exposed to sound waves of those frequencies. When constructed, the air chamber 322 and neck port 324, which are hollow to contain air, are enclosed in a supporting structure 326 through which the neck port 324 extends to couple the chamber to the air propagating the sound wave.

FIG. 3 also illustrates the unit cell's variable dimensions including the chamber height (H), and in the example of a cylindrical air chamber, the chamber's diameter (D) which is twice the radius, such that a cylindrical air chamber's volume is:

$$V = {( π \times \frac{1}{2} D )}^{2} \times H .$$

The neck port, which is also a cylindrical tube in this example, has an area of

$${( π \times \frac{1}{2} W )}^{2}$$

and a length of L. A unit cell is not limited to cylindrical air chambers or cylindrical necks, but can be of any suitable shape that facilitates resonating at the desired frequency in a manner that phase cancels the incoming sound wave of that frequency.

The result is highly efficient sound absorption at specific frequencies. By designing multiple unit cell resonators (block 328) as shown in FIG. 3, the metasurface 312 is particularly useful for targeted noise reduction in environments where controlling specific frequencies is beneficial, such as in architectural acoustics, automotive design, and industrial settings. The dimensions are deep subwavelength values relative to the subwavelength of the incoming wave. For example, one unit cell implementation was designed to inverse phase cancel an incoming frequency of 1310 Hz, with selected unit-cell dimensions of D=18 mm, H=16 mm, L=6 mm, W=3.2 mm. The resulting absorption coefficient of the designed unit-cell achieved near-perfect (greater than 98 percent absorption at the designed frequency 1310 Hz). Such a structure is deeply sub-wavelength; the wavelength λ at 1310 Hz in air is 260 mm, which is controlled by unit-cell with thickness of 22 mm. As can be seen, the above-selected dimensions of D, H, L and W for 1310 hertz (λ=260 m) in air range from about λ/14 to λ/81 (or λ/13 if based on the thickness of 22 mm).

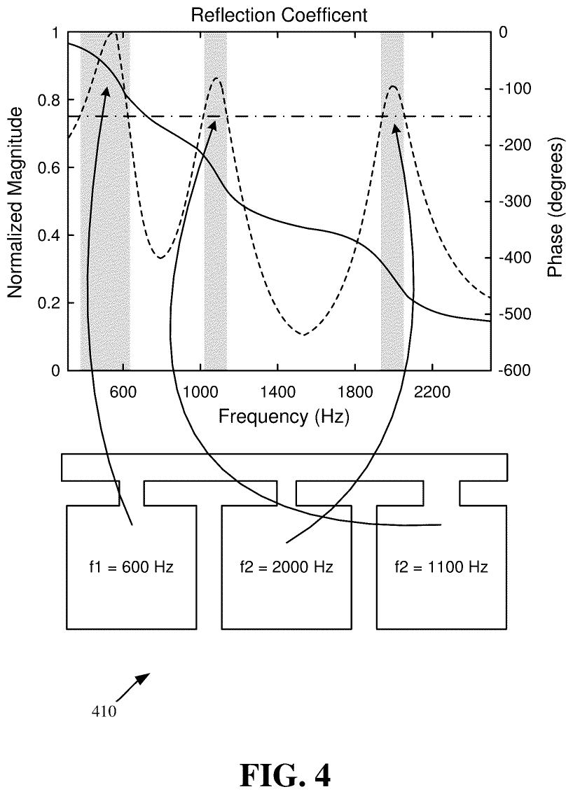

FIG. 4 shows the concept of a metasurface of a partial group of unit cells 410 designed for noise canceling three distinct frequencies, that is, the metasurface is designed for multiband noise cancelation. As depicted in FIGS. 3 and 4, an illustrative example of a tri-band sound absorption metamaterial results from the geometry of the structure, designed using the equations described herein for Helmholtz resonators that target three discrete frequencies. The effectiveness of the design can be verified by plotting the reflection coefficient of the proposed structure across the frequency spectrum, as shown in FIG. 4. The gray areas in the plot highlight regions of high absorption, exceeding seventy-five percent at the three intended frequencies.

A metasurface structure can be extended to encompass additional frequency bands. However, this extension comes at the expense of reduced absorption as the frequency bands widen. This phenomenon is also discernible in the plot of FIG. 4, where the lowest frequency exhibits nearly perfect absorption (greater than ninety-eight percent), while the highest frequency achieves a still highly beneficial absorption rate of around eighty percent.

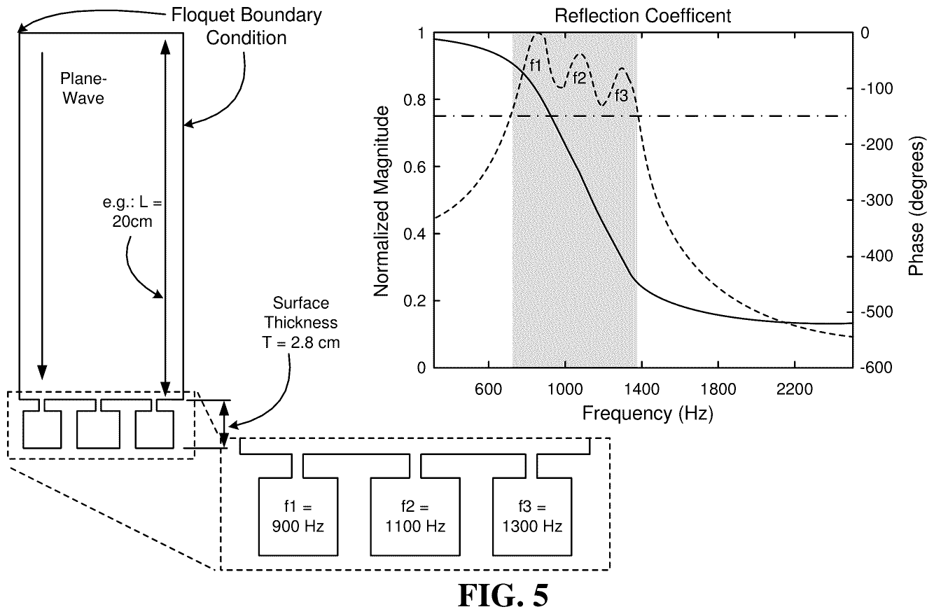

As noted herein, one prominent limitation of Helmholtz resonators, in contrast to other existing methods, is their narrow-band nature. This limitation is ameliorated by organizing sub-cells with resonant frequencies in close proximity to each other. Such an arrangement broadens the resonant frequency within the super-cell and the overall structure. As depicted in FIG. 5, this sub-cell approach yields high absorption rates (greater than seventy-five percent), spanning a broadband range from about 750 Hz to 1400 Hz, based on a pattern of three interleaving resonators designed for absorbing relatively close frequencies of 900 Hz, 1100 Hz and 1100 Hz. Note that a single metasurface can be designed for both broadband and multiband frequency absorption, and/or different multiple metasurfaces can be deployed.

The designed unit-cell only needs air and its surrounding acoustic hard boundaries. This is different from other approaches using porous and fibrous materials and gradient index materials. At this scale the unit-cell acts almost like a point towards the wave, so this design is not straightforward. However, the materials and the compact design in mm-scale/deeply sub-wavelength facilitate fabricating the unit cell as a thin, light-weight, and cost effective absorber with 3D printing technology.

The sound absorbing unit-cell can be fabricated using 3D printing technology with the features of material simplicity and deeply sub-wavelength compact design. One such metasurface was implemented with a 4 cm thickness and a 40 cm by 40 cm width and length. Note that while a symmetrical array of interleaved patterns is one suitable example, this is only one non-limiting example. Further note that the entire metasurface can be 3D printed, with selectively different materials for the unit cell supporting structure compared to the remainder of the metasurface that houses the unit cells, including, for example, a high thermal conductivity material (such as aluminum nitrate) for at least part of the metasurface containing the arrangement of unit cells. In this way, the high thermal conductivity material better transfers the heat away from the server or the like for dissipation in the surrounding environment, e.g., the air of a room. If only the unit cell portions are 3D printed, the non-unit cell part of the metasurface can be machined to accept and contain the separately printed or otherwise constructed unit cells, e.g., one subsurface with openings appropriately-sized for the chamber dimensions, and another subsurface with openings appropriately-sized for the neck dimensions, which when joined form the metasurface.

The entire structure can have a significantly reduced weight and material cost compared to the other sound absorbing alternatives. For example, the air cavities of the unit cells occupy a reasonable percent of the space in the solid supporting structure. The 3D printing technology can use a grid structure for the solid part, with an average of a relatively low percent of material usage using a common cross-grid structure. Combining these two factors, the designed example structure contains a significant percentage of air, reducing overall weight and material usage.

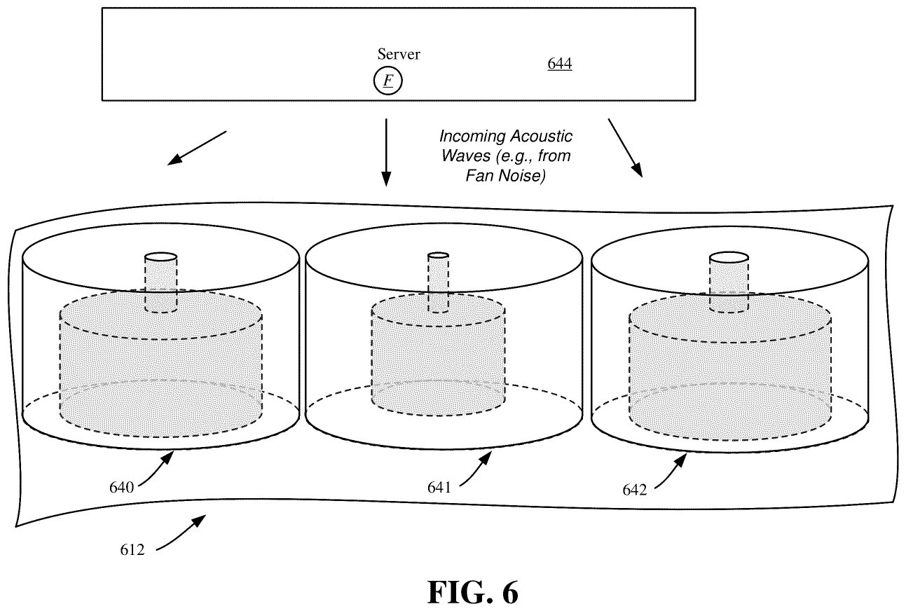

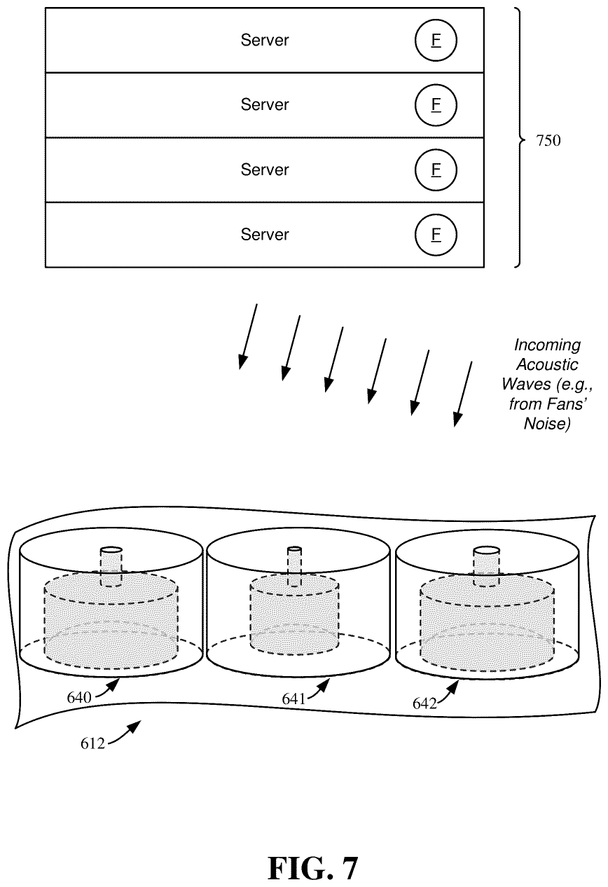

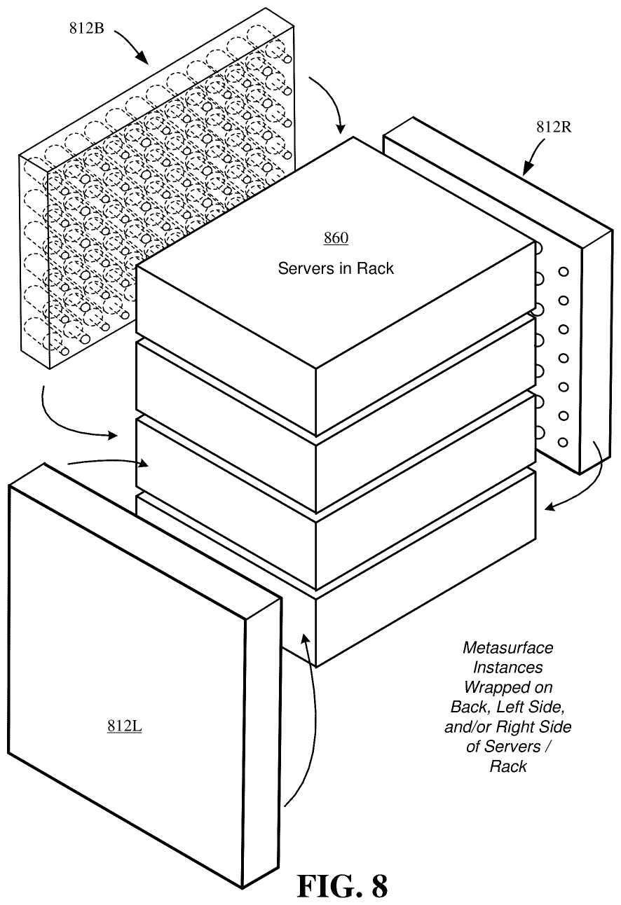

FIG. 6 depicts an example usage scenario, in which a portion of a metasurface 612 is shown with three enlarged unit cells 640-642 positioned proximate a server 644 to absorb noise emanating from the server's fan F. Although not explicitly shown herein, a metasurface as described herein, or multiple metasurfaces, can be positioned as an absorber proximate to a server 644 (FIG. 6) or rack of servers 750 (FIG. 7), and/or wrapped around at least part of a server or rack of servers 860 (metasurfaces 812B, 812L and 812R) as depicted in FIG. 8.

Validation of single-frequency sound absorption via the above-described metasurface structure, which was designed to be effective within multiple narrowband frequency ranges or a broadband frequency range, was proved experimentally. Note that each unit cell of the designed surface will primarily absorb sound at the specific frequency for which it is designed, even if incoming noise is broadband across a larger spectrum.

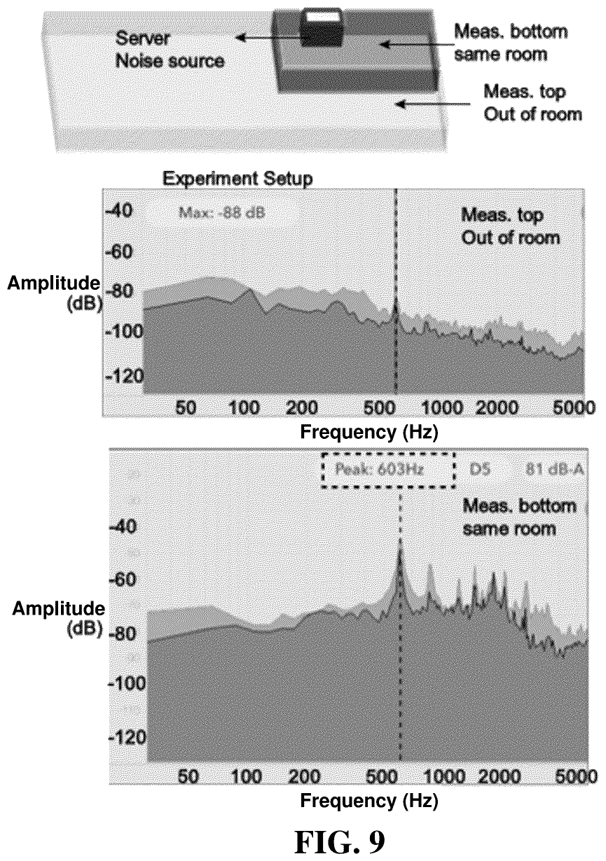

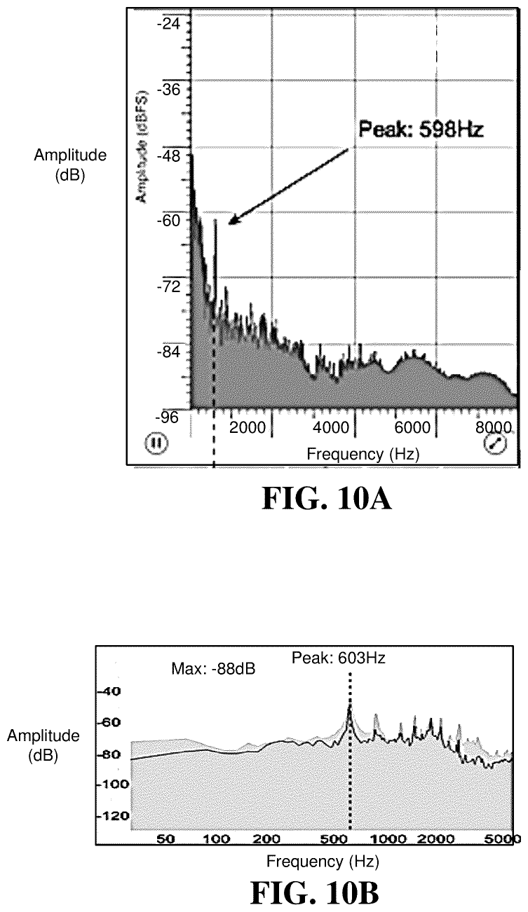

Measurements were performed using an actual server with a metasurface positioned proximate to the server, including being measured within the same room as the server and measured outside the room. The results are depicted in FIGS. 9, 10 and 10B. The measurements indicate the primary noise frequency as around 600 Hz. Notably, when measuring within the same room, a secondary noise frequency at 2000 Hz emerges. This observation emphasizes the value of a multiple frequency sound-absorbing metamaterial, which can attain high absorption rates (greater than seventy-five percent) precisely at these designated frequencies, underscoring the metasurface's effectiveness in mitigating noise in such server application scenarios.

One or more embodiments can be embodied in a system, such as described and represented in the drawing figures herein. The system can include a group of unit cells of a metasurface configured for sound absorption, the group of unit cells having dimensions that are deep subwavelength values relative to wavelengths of incoming acoustic waves of combined frequencies. The group of unit cells can include a first unit cell, which can include a first air cavity within a first solid supporting structure, the first air cavity can include a first chamber having a first chamber volume with a first chamber width dimension and a first neck port; the first neck port can have a first neck volume with a first neck width dimension that is narrower than the first chamber width dimension, and the first neck port can extend through the first solid supporting structure and can be coupled to the first chamber to expose the incoming acoustic waves to air in the first chamber. The first chamber volume and the first neck volume can determine a first resonant frequency of the first unit cell to resonate the first unit cell at the first resonant frequency, to phase cancel a first frequency of the incoming acoustic waves, when exposed to the incoming acoustic waves. the system further can include a second unit cell, which can include a second air cavity within a second solid supporting structure; the second air cavity which can include a second chamber having a second chamber volume with a second chamber width dimension and a second neck port, and the second neck port can have a second neck volume with a second neck width dimension that is narrower than the second chamber width dimension. The second neck port can extend through the second solid supporting structure and can be coupled to the second chamber to expose the incoming acoustic waves to air in the second chamber; the second chamber volume and the second neck volume can determine a second resonant frequency of the second unit cell to resonate the second unit cell at the second resonant frequency, to phase cancel a second frequency of the incoming acoustic waves, when exposed to the incoming acoustic waves.

The first air cavity, the first neck port and the first solid supporting structure can form a Helmholtz resonator.

The first unit cell can be one first unit cell of a first subgroup of respective first unit cells, and the second unit cell can be one second unit cell of a second subgroup of respective second unit cells.

The first chamber can include a first chamber cylinder dimensioned with the first chamber width dimension and a first chamber height dimension, and the first chamber volume can be based on the first chamber height dimension and a first chamber circular area corresponding to the first chamber width dimension. The first neck port can include a first neck cylinder dimensioned with the first neck width dimension and a first neck height dimension, and the first neck volume can be based on the first neck height dimension and a first neck circular area corresponding to the first neck width dimension.

The first unit cell can be incorporated into a metasurface comprising an array of unit cells. The metasurface can be positioned proximate at least one of: a server, wherein the incoming acoustic waves result from operation of a cooling fan of the server, or a rack of servers, wherein the incoming acoustic waves result from operation of cooling fans of the rack of servers.

The first unit cell can be formed by a three-dimensional printer that prints the first solid supporting structure in layers in conjunction with omitting printing of the first chamber and the first neck port.

The first frequency of the incoming acoustic waves and the second frequency of the incoming acoustic waves can be more than one kilohertz apart from each other.

The system further can include a third unit cell, which can include a third air cavity within a third solid supporting structure; the third air cavity can include a third chamber having a third chamber volume with a third chamber width dimension and a third neck port. The third neck port can have a third neck volume with a third neck width dimension that is narrower than the third chamber width dimension; the third neck port can extend through the third solid supporting structure and can be coupled to the third chamber to expose the incoming acoustic waves to air in the third chamber. The third chamber volume and the third neck volume can determine a third resonant frequency of the third unit cell to resonate the third unit cell at the third resonant frequency, to phase cancel a third frequency of the incoming acoustic waves, when exposed to the incoming acoustic waves. the first frequency of the incoming acoustic waves, the second frequency of the incoming acoustic waves, and the third frequency of the incoming acoustic waves can be within one kilohertz of each other.

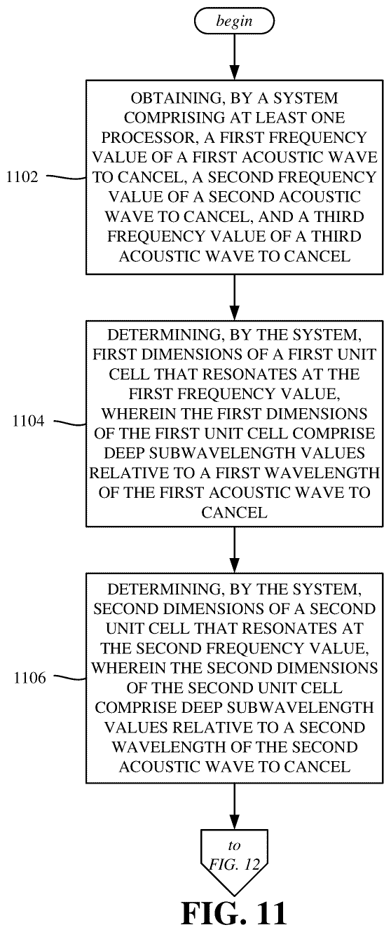

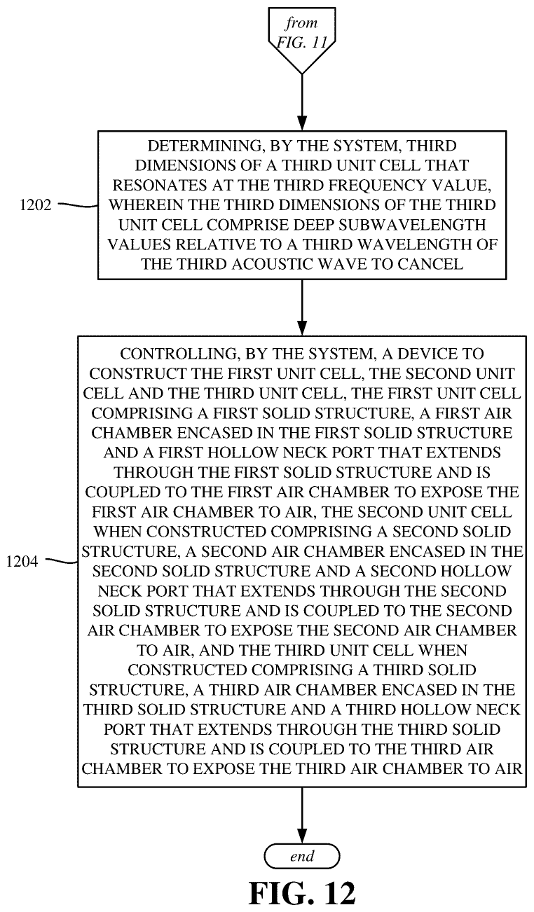

One or more example embodiments, such as corresponding to example operations of a method, are represented in FIGS. 11 and 12. Example operation 1102 represents obtaining, by a system comprising at least one processor, a first frequency value of a first acoustic wave to cancel, a second frequency value of a second acoustic wave to cancel, and a third frequency value of a third acoustic wave to cancel. Example operation 1104 represents determining, by the system, first dimensions of a first unit cell that resonates at the first frequency value, wherein the first dimensions of the first unit cell comprise deep subwavelength values relative to a first wavelength of the first acoustic wave to cancel. Example operation 1106 represents determining, by the system, second dimensions of a second unit cell that resonates at the second frequency value, wherein the second dimensions of the second unit cell comprise deep subwavelength values relative to a second wavelength of the second acoustic wave to cancel. The operations continue at FIG. 12, where example operation 1202 represents determining, by the system, third dimensions of a third unit cell that resonates at the third frequency value, wherein the third dimensions of the third unit cell comprise deep subwavelength values relative to a third wavelength of the third acoustic wave to cancel. Example operation 1204 represents controlling, by the system, a device to construct the first unit cell, the second unit cell and the third unit cell, the first unit cell comprising a first solid structure, a first air chamber encased in the first solid structure and a first hollow neck port that extends through the first solid structure and is coupled to the first air chamber to expose the first air chamber to air, the second unit cell when constructed comprising a second solid structure, a second air chamber encased in the second solid structure and a second hollow neck port that extends through the second solid structure and is coupled to the second air chamber to expose the second air chamber to air, and the third unit cell when constructed comprising a third solid structure, a third air chamber encased in the third solid structure and a third hollow neck port that extends through the third solid structure and is coupled to the third air chamber to expose the third air chamber to air.

The first neck port can be a right circular cylinder, and determining the dimensions of the first unit cell can include determining a first neck port height and a first neck port radius.

The first air chamber can be a right circular cylinder, and determining the dimensions of the first unit cell can include determining a first chamber height and a first chamber radius.

Controlling the device to construct the first unit cell, the second unit cell, and the third unit cell can include communicating with a three-dimensional printer.

One or more embodiments can be embodied in a metasurface, such as described and represented in the drawing figures herein. The metasurface can include a base structure, and a group of unit cells contained by the base structure. The group of unit cells can include a first subgroup of respective first unit cells, and a second subgroup of respective second unit cells, in which the respective first unit cells can include respective first Helmholtz resonators that can include respective first air chambers coupled to respective first neck ports that extend to a surface of the base structure to facilitate air flow to the respective first air chambers. The respective second unit cells can include respective second Helmholtz resonators that can include respective second air chambers coupled to respective second neck ports that extend to a surface of the base structure to facilitate air flow to the respective second air chambers. The respective first unit cells can be configured with respective first deep subwavelength dimensions relative to first wavelengths of incoming acoustic waves having a first specific frequency value within a first narrowband frequency range, and the respective second unit cells can be configured with respective second deep subwavelength dimensions relative to second wavelengths of the incoming acoustic waves having a second specific frequency value within a second narrowband frequency range. The first deep subwavelength dimensions can be selected to resonate the respective first unit cells at the first specific frequency value to collectively phase cancel a first frequency of the incoming acoustic waves when exposed to the incoming acoustic waves, and the second deep subwavelength dimensions can be selected to resonate the respective second unit cells at the second specific frequency value to collectively phase cancel a second frequency of the incoming acoustic waves when exposed to the incoming acoustic waves.

The respective first unit cells can be evenly distributed in a first array pattern within the base structure, and the respective second unit cells can be evenly distributed in a second array pattern, interleaved with the first array pattern, within the base structure.

The respective first unit cells can include respective first cylindrical neck ports and respective first cylindrical air chambers.

The metasurface can be configured to collectively phase cancel the incoming acoustic waves emanating from at least one server.

The base structure can include a high thermal conductivity material to facilitate conduction of heat from the at least one server to a medium external to the at least one server.

As can be seen, the technology described herein facilitates construction and deployment of a metasurface of unit cells, which can be implemented in a practical, compact and lightweight surface configuration. As one example, the metasurface is highly useful in the context of mitigating server noise, including for broadband and/or multiband server noise scenarios. One design of subgroups of unit-cells achieved high sound absorption of an incoming sound waves at the frequencies for which it was designed. Based on the technology described herein, thin, light-weight, and cost effective sound absorbers can be constructed, including by using 3D printing technology or the like.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a group of unit cells of a metasurface configured for sound absorption, the group of unit cells having dimensions that are deep subwavelength values relative to wavelengths of incoming acoustic waves of combined frequencies, the group of unit cells comprising:
a first unit cell, the first unit cell comprising a first air cavity within a first solid supporting structure, the first air cavity comprising a first chamber having a first chamber volume with a first chamber width dimension and a first neck port, wherein the first neck port has a first neck volume with a first neck width dimension that is narrower than the first chamber width dimension, wherein the first neck port extends through the first solid supporting structure and is coupled to the first chamber to expose the incoming acoustic waves to air in the first chamber, and wherein the first chamber volume and the first neck volume determine a first resonant frequency of the first unit cell to resonate the first unit cell at the first resonant frequency, to phase cancel a first frequency of the incoming acoustic waves, when exposed to the incoming acoustic waves; and
a second unit cell, the second unit cell comprising a second air cavity within a second solid supporting structure, the second air cavity comprising a second chamber having a second chamber volume with a second chamber width dimension and a second neck port, wherein the second neck port has a second neck volume with a second neck width dimension that is narrower than the second chamber width dimension, wherein the second neck port extends through the second solid supporting structure and is coupled to the second chamber to expose the incoming acoustic waves to air in the second chamber, and wherein the second chamber volume and the second neck volume determine a second resonant frequency of the second unit cell to resonate the second unit cell at the second resonant frequency, to phase cancel a second frequency of the incoming acoustic waves, when exposed to the incoming acoustic waves.

2. The system of claim 1, wherein the first air cavity, the first neck port and the first solid supporting structure form a Helmholtz resonator.

3. The system of claim 1, wherein the first unit cell is one first unit cell of a first subgroup of respective first unit cells, and wherein the second unit cell is one second unit cell of a second subgroup of respective second unit cells.

4. The system of claim 1, wherein the first chamber comprises a first chamber cylinder dimensioned with the first chamber width dimension and a first chamber height dimension, and wherein the first chamber volume is based on the first chamber height dimension and a first chamber circular area corresponding to the first chamber width dimension.

5. The system of claim 4, wherein the first neck port comprises a first neck cylinder dimensioned with the first neck width dimension and a first neck height dimension, and wherein the first neck volume is based on the first neck height dimension and a first neck circular area corresponding to the first neck width dimension.

6. The system of claim 1, wherein the first unit cell is incorporated into a metasurface comprising an array of unit cells.

7. The system of claim 6, wherein the metasurface is positioned proximate at least one of:
a server, wherein the incoming acoustic waves result from operation of a cooling fan of the server, or
a rack of servers, wherein the incoming acoustic waves result from operation of cooling fans of the rack of servers.

8. The system of claim 1, wherein the first unit cell is formed by a three-dimensional printer that prints the first solid supporting structure in layers in conjunction with omitting printing of the first chamber and the first neck port.

9. The system of claim 1, wherein the first frequency of the incoming acoustic waves and the second frequency of the incoming acoustic waves are more than one kilohertz apart from each other.

10. The system of claim 1, further comprising a third unit cell, the third unit cell comprising a third air cavity within a third solid supporting structure, the third air cavity comprising a third chamber having a third chamber volume with a third chamber width dimension and a third neck port, wherein the third neck port has a third neck volume with a third neck width dimension that is narrower than the third chamber width dimension, wherein the third neck port extends through the third solid supporting structure and is coupled to the third chamber to expose the incoming acoustic waves to air in the third chamber, and wherein the third chamber volume and the third neck volume determine a third resonant frequency of the third unit cell to resonate the third unit cell at the third resonant frequency, to phase cancel a third frequency of the incoming acoustic waves, when exposed to the incoming acoustic waves.

11. The system of claim 10, wherein the first frequency of the incoming acoustic waves, the second frequency of the incoming acoustic waves, and the third frequency of the incoming acoustic waves are within one kilohertz of each other.

12. A method, comprising:
obtaining, by a system comprising at least one processor, a first frequency value of a first acoustic wave to cancel, a second frequency value of a second acoustic wave to cancel, and a third frequency value of a third acoustic wave to cancel;
determining, by the system, first dimensions of a first unit cell that resonates at the first frequency value, wherein the first dimensions of the first unit cell comprise deep subwavelength values relative to a first wavelength of the first acoustic wave to cancel;
determining, by the system, second dimensions of a second unit cell that resonates at the second frequency value, wherein the second dimensions of the second unit cell comprise deep subwavelength values relative to a second wavelength of the second acoustic wave to cancel; and
determining, by the system, third dimensions of a third unit cell that resonates at the third frequency value, wherein the third dimensions of the third unit cell comprise deep subwavelength values relative to a third wavelength of the third acoustic wave to cancel; and
controlling, by the system, a device to construct the first unit cell, the second unit cell and the third unit cell, the first unit cell comprising a first solid structure, a first air chamber encased in the first solid structure and a first hollow neck port that extends through the first solid structure and is coupled to the first air chamber to expose the first air chamber to air, the second unit cell when constructed comprising a second solid structure, a second air chamber encased in the second solid structure and a second hollow neck port that extends through the second solid structure and is coupled to the second air chamber to expose the second air chamber to air, and the third unit cell when constructed comprising a third solid structure, a third air chamber encased in the third solid structure and a third hollow neck port that extends through the third solid structure and is coupled to the third air chamber to expose the third air chamber to air.

13. The method of claim 12, wherein the first neck port is a right circular cylinder, and wherein the determining of the dimensions of the first unit cell comprises determining a first neck port height and a first neck port radius.

14. The method of claim 12, wherein the first air chamber is a right circular cylinder, and wherein the determining of the dimensions of the first unit cell comprises determining a first chamber height and a first chamber radius.

15. The method of claim 12, wherein the controlling of the device to construct the first unit cell, the second unit cell, and the third unit cell comprises communicating with a three-dimensional printer.

16. A metasurface, comprising:
a base structure; and
a group of unit cells contained by the base structure, the group of unit cells comprising a first subgroup of respective first unit cells, and a second subgroup of respective second unit cells;
wherein the respective first unit cells comprise respective first Helmholtz resonators comprising respective first air chambers coupled to respective first neck ports that extend to a surface of the base structure to facilitate air flow to the respective first air chambers, and wherein the respective second unit cells comprise respective second Helmholtz resonators comprising respective second air chambers coupled to respective second neck ports that extend to a surface of the base structure to facilitate air flow to the respective second air chambers,
wherein the respective first unit cells are configured with respective first deep subwavelength dimensions relative to first wavelengths of incoming acoustic waves having a first specific frequency value within a first narrowband frequency range, and wherein the respective second unit cells are configured with respective second deep subwavelength dimensions relative to second wavelengths of the incoming acoustic waves having a second specific frequency value within a second narrowband frequency range, and
wherein the first deep subwavelength dimensions are selected to resonate the respective first unit cells at the first specific frequency value to collectively phase cancel a first frequency of the incoming acoustic waves when exposed to the incoming acoustic waves, and wherein the second deep subwavelength dimensions are selected to resonate the respective second unit cells at the second specific frequency value to collectively phase cancel a second frequency of the incoming acoustic waves when exposed to the incoming acoustic waves.

17. The metasurface of claim 16, wherein the respective first unit cells are evenly distributed in a first array pattern within the base structure, and wherein the respective second unit cells are evenly distributed in a second array pattern, interleaved with the first array pattern, within the base structure.

18. The metasurface of claim 16, wherein the respective first unit cells comprise respective first cylindrical neck ports and respective first cylindrical air chambers.

19. The metasurface of claim 16, wherein the metasurface is configured to collectively phase cancel the incoming acoustic waves emanating from at least one server.

20. The metasurface of claim 19, wherein the base structure comprises a high thermal conductivity material to facilitate conduction of heat from the at least one server to a medium external to the at least one server.
